(19) United States
(12) Patent Application Publication
(10) Pub. No.: US 2026/0178995 A1
(43) Pub. Date: Jun. 25, 2026

(54) Assessing Cotton Suppliers

(71) Applicant: Uster Technologies AG, Uster (CH)

(72) Inventors: Daniel BÜHLER, Uster (CH); Efstratios FRAGKOTSINOS, Uster (CH); Adrian GENOUD, Uster (CH); Stergios PANTERMAS, Uster (CH); Mario SIEGENTHALER, Herdern (CH); Wolfram Ulrich SÖLL, Uster (CH)

(73) Assignee: Uster Technologies AG, Uster (CH)

(21) Appl. No.: 19/127,107

(22) PCT Filed: Nov. 16, 2023
(86) PCT No.: PCT/CH2023/050038

§ 371 Date: May 3, 2025

(30) Foreign Application Priority Data
Nov. 22, 2022 (CH) CH0013902022
Nov. 22, 2022 (CH) CH0013912022
Jun. 7, 2023 (CH) CH0006022023

(51) Int. Cl. G06Q 10/04; G06F 16/2457; G06F 16/951; G06Q 10/08; G06Q 10/087; G06Q 30/0201; G06Q 30/0601

(52) U.S. Cl. CPC G06Q 10/04; G06F 16/24578; G06F 16/951; G06Q 10/08; G06Q 10/087; G06Q 30/0201; G06Q 30/0603

(57) ABSTRACT

The computer-implemented method serves for assessing cotton suppliers supplying raw cotton to cotton processors (2.1-2.4). It comprises the steps of: receiving by a server computer system (1) from at least one cotton processor (2.1-2.4) measurement sets for different cotton samples, each measurement set comprising at least one measured value for at least one cotton-quality parameter (a-h), and information on the cotton supplier of the cotton sample; assigning to each measurement set the information on the cotton supplier; storing in a database (12) the measurement sets together with the assigned information; statistically evaluating the measurement sets; and transmitting a result of the statistical evaluation comparing at least two different cotton suppliers, together with the information on the at least two cotton suppliers, to a client computer (8). The method facilitates an efficient and environmentally friendly trading of raw cotton.

### FIELD OF THE INVENTION

The present invention lies in the fields of raw-cotton quality determination and cotton trading. It relates to a computer-implemented method and a server computer system for assessing cotton suppliers, according to the independent patent claims.

### DESCRIPTION OF THE PRIOR ART

U.S. Pat. No. 5,489,028 A discloses a method of removing foreign material from a row of fiber bales and a bale opening machine therefor. The bale opening machine is provided with a detection unit upstream of the bale opener for detecting the presence of foreign material at the surface of the fiber bale. In addition, an extraction unit is mounted adjacent the bale opener for removing the detected foreign material from a fiber bale.

The brochure “USTER® HVI 1000—The fiber classification and analysis system”, Uster Technologies AG, 2018, describes a laboratory instrument for measuring color characteristics, trash particle content, fineness and maturity characteristics, micronaire, length, short-fiber, tensile properties, and nep content of textile fibers. The brochure “USTER® AFIS PRO 2—The fiber process control system”, Uster Technologies AG, 2016, describes a laboratory instrument for measuring neps, length, short-fiber, maturity, fineness, trash, and dust characteristics of textile fibers.

CN-114′742′429 A discloses a computer-implemented method for assessing spinning mills. A server computer system receives from a spinning mill having produced a yarn package a set of measured values for at least one yarn-quality parameter measured for yarn on the yarn package. It assigns to the set of measured values a mill identifier for the respective spinning mill and stores in a database the set of measured values together with the assigned mill identifier. These steps are repeated for at least one other spinning mill.

The server computer system produces a ranking of the spinning mills according to the sets of measured values and the mill identifiers. It transmits the ranking to a client computer. The method facilitates an efficient trading of yarn packages.

In order to compare the quality level of one textile mill with another's, a common “quality language” is needed. Worldwide accepted quality benchmarks or quality references in the textile industry are the USTER® STATISTICS; see USTER® NEWS BULLETIN Nos. 49 and 51, Uster Technologies AG, November 2012 and October 2018, respectively. The USTER® STATISTICS are a comprehensive statistical survey of the quality of textile materials produced worldwide. They essentially contain statistical data in the form of graphs with percentile curves for numerous parameters and textile materials. These graphical cumulative frequency representations statistically indicate the extent by which a certain textile material is above or below a certain quality-parameter value. For instance, a percentile value of 25 means that 25% of the textile mills worldwide produce the respective product with the same or lower value of the respective quality parameter. Numerical editions, as opposed to graphical, are also available. The USTER® STATISTICS are made available by Uster Technologies AG via the internet (https://www.uster.com/value-added-services/uster-statistics/).

Raw cotton is bought from cotton suppliers mainly by spinning mills. Cotton buyers want to source cotton efficiently in the right amount and quality for their downstream application. Nowadays a cotton buyer selects a cotton supplier by virtue of human experience, mainly based on price, availability, and further parameters of a certain cotton type. Such a selection often does not fit the quality parameters requested by the end product, i.e., yarn. Since the raw material plays a dominant role in the value chain of a spinning mill, material waste should be avoided. Sometimes cotton bales or whole lots have to be returned due to their unsatisfactory quality and/or consistency, and sometimes orders are not placed due to disappointing sampling results. Moreover, selecting suppliers by virtue of human experience rarely yields optimum results, apart from the fact that experienced textile workers might not be available.

### SUMMARY OF THE INVENTION

It is an object of the present invention to provide a technical infrastructure that avoids the drawbacks of the prior art and thus facilitates an efficient and more environmentally friendly trading of raw cotton. The computer-implemented method and server computer system shall allow cotton buyers to objectively assess and compare various cotton samples and/or suppliers and, based on the assessment, purchase exactly the cotton quality needed. They shall make costly and lengthy acceptance trials obsolete. With no or less acceptance trials, less samples have to be transported and less material is wasted. Wasted shipping of cotton samples and/or whole cotton lots shall be avoided.

These and other objects are solved by the computer-implemented method and server computer system as defined in the independent claims. Advantageous embodiments are specified in the dependent claims.

The computer-implemented method according to the invention serves for assessing cotton suppliers supplying raw cotton to cotton processors. It comprises the steps of: receiving by a server computer system via a global communication network from at least one cotton processor measurement sets for different cotton samples, each measurement set comprising at least one measured value for at least one cotton-quality parameter measured for the respective cotton sample, and information on the cotton supplier of the respective cotton sample; assigning by the server computer system to each measurement set the information on the cotton supplier of the respective cotton sample; storing in a database on the server computer system the measurement sets together with the assigned information on the cotton supplier; statistically evaluating the measurement sets by the server computer system; and transmitting a result of the statistical evaluation comparing at least two different cotton suppliers, together with the information on the at least two cotton suppliers, from the server computer system via a global communication network to a client computer.

According to a first embodiment of the invention, the at least one measured value is determined on a cotton bale in a bale laydown in an opening department of a spinning-preparation plant. The at least one cotton-quality parameter can be at least one element of the following set: humidity, reflectance, color characteristics, contamination content, color characteristics of contaminations, type of contaminations.

According to a second embodiment of the invention, the at least one measured value is determined in a textile laboratory by a fiber-testing laboratory instrument. The at least one cotton-quality parameter can be at least one element of the following set: reflectance, color characteristics, fiber length, fiber strength, tensile properties, short-fiber characteristics, trash-particle content, trash-particle size, nep content, nep size, fiber-fineness characteristics, fiber-maturity characteristics, micronaire.

According to a combination of the first and second embodiments, each of the measurement sets comprises at least one first measured value determined on a cotton bale in a bale laydown in an opening department of a spinning-preparation plant and at least one second measured value determined in a textile laboratory by a fiber-testing laboratory instrument.

A further embodiment further comprises the steps of: assigning by the server computer system to each measurement set a sample identifier for the respective cotton sample; and storing in the database the sample identifiers together with the measurement sets. In this embodiment, the following further steps can be performed: receiving by the server computer system via the global communication network from the at least one cotton processor further information on the cotton samples; assigning by the server computer system to each piece of further information the sample identifier for the respective cotton sample; and storing in the database the further information together with the measurement sets. The further information can be from the following set: plant variety, geographic origin, year of harvest, ginning mill, price, quantity supplied, processor of the cotton sample.

According to one embodiment, the raw cotton is supplied in the form of cotton bales to the at least one cotton processor. This embodiment further comprises the steps of: assigning by the server computer system to each measurement set a bale identifier for the respective cotton bale; and storing in the database the bale identifiers together with the measurement sets.

The statistical evaluation can be based on all measurement sets stored in the database, based on a certain number of most recent measurement sets, or based on most recent measurement sets measured in a certain time period.

In one embodiment, the statistical evaluation includes producing a ranking of the cotton suppliers, and the ranking is transmitted from the server computer system via the global communication network to the client computer. The ranking is produced, e.g., on an ordinal scale, on an interval scale or on a ratio scale. The ranking can be in the form of measured values, in the form of quantiles or percentiles, in the form of ordinal numbers, and/or in the form of classes.

The invention also encompasses a server computer system comprising means for carrying out at least one of the methods described above.

The invention further encompasses a computer program having instructions which when executed by a server computer system cause the server computer system to perform at least one of the methods described above.

The server computer system according to the invention serves for assessing cotton suppliers supplying raw cotton to cotton processors. It comprises a receiver for receiving via a global communication network from at least one cotton processor measurement sets for different cotton samples, each measurement set comprising at least one measured value for at least one cotton-quality parameter measured for the respective cotton sample, and information on the cotton supplier of the respective cotton sample; a processor configured to assign to each measurement set the information on the cotton supplier of the respective cotton sample; a memory for storing in a database the measurement sets together with the assigned information on the cotton supplier; a processor configured to statistically evaluate the measurement sets; and a transmitter for transmitting a result of the statistical evaluation comparing at least two different cotton suppliers, together with the information on the at least two cotton suppliers, from the server computer system via a global communication network to a client computer.

As used in this document, the term “sample” means a related quantity of raw cotton provided by one supplier, from one plant variety, having the same geographic origin and year of harvest, having been processed by one ginning mill. The physical properties are substantially homogeneously distributed within the sample. The size of the sample may range from a fiber flock having a mass of less than 1 g to a lot consisting of several tons of cotton.

In this document, an “ordinal scale” is a variable measurement scale used to simply depict the order of variables and not the difference between each of the variables. An “interval scale” allows for the degree of difference between variables but does not indicate any zero point. A “ratio scale” additionally provides information on the value of true zero and thus allows for the ratio of variables.

A “server computer system” as used in this document may consist of several pieces of computer hardware suitably connected for communicating with each other. Such pieces of computer hardware need not necessarily be located at the same site but may rather be distributed over different locations.

A “buyer” as used in this document can be an end user of the raw cotton, such as a spinning mill, or any intermediary who resells or conveys the raw cotton to another buyer. In the latter case, the intermediary need not perform a monetary transaction in the strict sense of buying.

As used in this document, a “processor of raw cotton” can be any entity or person capable of measuring values for at least one cotton-quality parameter for a cotton sample. Examples of a processor of raw cotton are a buyer as defined above or a provider of cotton-grading services, such as the U.S. Department of Agriculture.

The present invention facilitates an efficient trading raw cotton. Thanks to it, cotton buyers can objectively assess various cotton suppliers and, based on the assessment, purchase exactly the cotton quality needed. Every cotton buyer gets information on the quality and consistency of cotton provided by suppliers offering raw cotton. Thus, costly and lengthy acceptance trials are no longer necessary or substantially reduced. Since the consistency of each cotton supplier is being measured and communicated to the buyers, unpleasant surprises in the form of outlier bales within a lot can be avoided. A wasted shipping of cotton bales and/or whole cotton lots, as well as returns of cotton bales of unsatisfactory quality, are thus avoided or drastically minimized. Insofar, the invention respects the environment. Quality and consistency within the cotton industry in general are improved.

### BRIEF DESCRIPTION OF THE DRAWINGS

In the following, the invention is explained in detail based on the drawings.

FIG. 1 schematically shows a server computer system according to the invention, together with its environment.

FIG. 2 schematically shows a side view of an opening department of a spinning-preparation plant.

FIG. 3 schematically shows tables of a database implemented in the server computer system according to the invention.

FIGS. 4 and 5 show examples of graphical representations of statistical evaluations.

### IMPLEMENTATION OF THE INVENTION

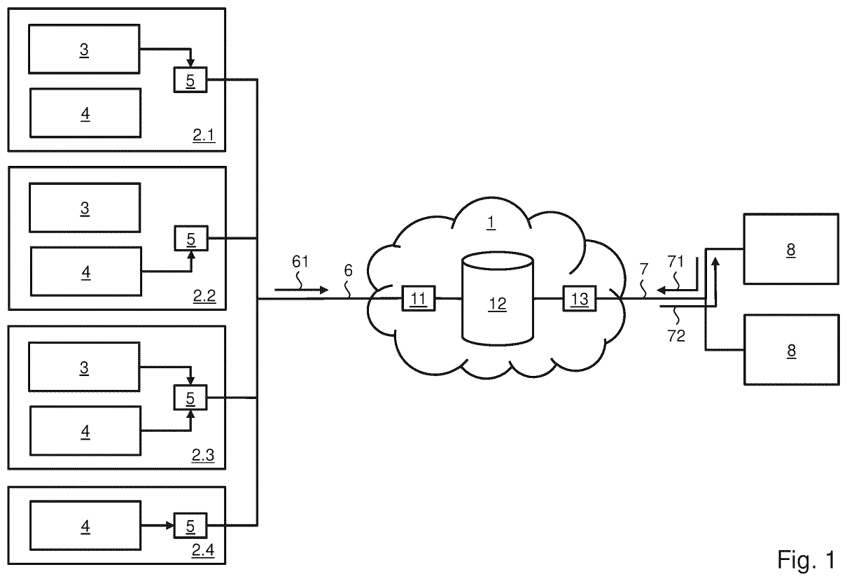

FIG. 1 schematically shows a server computer system 1 according to the invention, together with its environment. The server computer system 1 is preferably realized by means of cloud computing, i.e., employs remote shared computer resources, and is therefore symbolized by a cloud in FIG. 1. The server computer system 1 is connected via a global communication network 6 such as the world wide web with a plurality of cotton-processing plants or cotton processors, e.g., spinning mills 2.1-2.3, or cotton-classing offices 2.4. The server computer system 1 is also connected via a global communication network 7 such as the world wide web with a plurality of client computers 8, each of the client computers 8 being operated by a cotton buyer. Only three spinning mills 2.1-2.3, one cotton-classing office 2.4, and two client computers 8 are drawn in FIG. 1 for the sake of simplicity; however, in practice the numbers of spinning mills, cotton-classing offices and client computers can be lower or significantly higher.

For communicating with the cotton processors 2.1-2.4 and the client computers 8, the server computer system 1 is equipped with suitable communication means 11, 13. The communication means 11, 13 include hardware, such as routers, and software, such as application programming interfaces (APIs). They act as a receiver and/or transmitter each.

The spinning process from raw cotton to yarn includes several steps and can use several locations. In the representation of FIG. 1, only two sites 3, 4 of particular interest for the present invention are schematically drawn for each spinning mill 2.1-2.3, namely, an opening department 3 of a spinning-preparation plant and a textile laboratory 4.

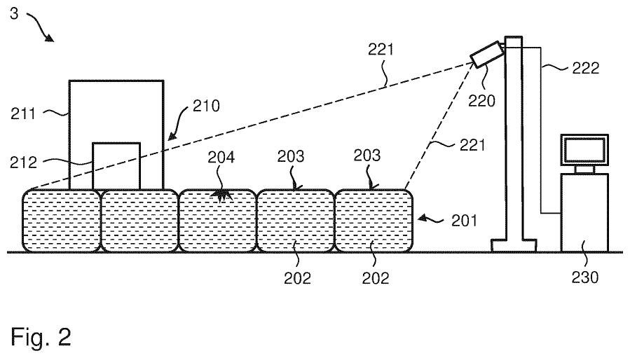

An opening department 3 of a spinning-preparation plant is schematically shown in FIG. 2. In the opening department 3, several raw-cotton bales 202 supplied by at least one cotton supplier are placed in continuous rows to form a bale laydown 201. An automatic bale opener 210 travels back and forth along the bale laydown 201, takes off in layers the cotton from bare surfaces 203 of the bales 202 and thus opens the cotton into fiber tufts. The bale opener 210 usually contains a tower-like head 211 and a height-adjustable taking-off arm 212 protruding from the head 211 over the bale laydown 201.

The individual cotton bales 202 can differ from each other with regard to various parameters. Examples of such cotton-quality parameters are the following: humidity, reflectance, color characteristics, contamination content, color characteristics of contaminations, and type of contaminations. Further parameters can be mathematical combinations of the parameters listed above and/or other parameters. In the schematic representation of FIG. 2, a contamination 204 is drawn on a surface of a cotton bale 202. At least one value for at least one cotton-quality parameter can be measured for a cotton sample. The cotton sample can consist of one cotton bale 202 or of a group of related bales 202.

The at least one cotton-quality parameter can be determined by means of a sensor device 220. In the example of FIG. 2, the sensor device 220 is stationary with respect to the bale laydown 201. The sensor device 220 can be at least one stationary digital camera which monitors the bare surface 203 of the cotton bales 202. A field of view 221 is schematically drawn in FIG. 2. Instead of one camera, several cameras can be used, which are preferably arranged along the bale laydown 201, are spaced from each other, and completely cover the bale laydown 201. The at least one camera 220 can be arranged on a ground, on a wall or on a ceiling of the spinning-preparation plant. The image processing and thus the determination of the at least one parameter value can take place inside or outside the at least one camera 220. For an external image processing, a computer 230 connected by a data line 222 to the at least one camera 220 can be provided.

Alternatively or additionally, the sensor device or part of it can be movable with respect to the bale laydown 201. For instance, it can be arranged on the bale opener 210, as is known from U.S. Pat. No. 5,489,028 A, or on a vehicle moving in the spinning-preparation plant.

Alternatively or additionally, the sensor device can differ from a digital camera. For instance, it can be a humidity sensor or a metal detector. Such sensor devices, as well as digital cameras, are known as such and need not be further explained here. Various sensor devices can be used simultaneously and can be stationary and/or movable with respect to the bale laydown 201. For instance, there can be several stationary cameras 220 and a humidity sensor arranged on the bale opener 210.

Cotton-quality parameters can also be measured in a textile laboratory 4 (see FIG. 1). Fiber-testing laboratory instruments such as USTER® HVI 1000 and USTER® AFIS PRO 2 needed for such measurements are known and available on the market. They can measure at least one cotton-quality parameter such as reflectance, color characteristics, fiber length, fiber strength, tensile properties, short-fiber characteristics, trash-particle content, trash-particle size, nep content, nep size, fiber-fineness characteristics, fiber-maturity characteristics, and micronaire. Further parameters can be mathematical combinations of the parameters listed above and/or other parameters. At least one value for at least one cotton-quality parameter can be measured for a cotton sample. The cotton sample can consist of one cotton bale or of a group of related bales. For the laboratory tests, one or several subsamples can be taken from each cotton sample.

The left-hand side of FIG. 1 illustrates various possibilities of determining the at least one measurement value for the at least one cotton-quality parameter at the cotton-processing plants 2.1-2.4. In a first spinning mill 2.1, the at least one measurement value is determined only in the opening department 3. In a second spinning mill 2.2, the at least one measurement value is determined only by a fiber-testing laboratory instrument in the textile laboratory 4. In a third spinning mill 2.3, at least two measurement values are determined—at least one in the opening department 3 and at least one in the textile laboratory 4. The cotton-classifying office 2.4 does not have any opening department and determines the at least one measurement value in the textile laboratory 4.

The at least one measured value for at least one cotton-quality parameter forms a measurement set. The measurement set and information on the cotton supplier of the respective cotton sample are transmitted from the cotton-processing plant 2.1-2.4 via the global communication network 6 to the server computer system 1, which data transmission is indicated by an arrow 61 in FIG. 1. For this purpose, the cotton-processing plant 2.1-2.4 can be equipped with a cloud connector 5 connected to the server computer system 1 via the global communication network 6. The server computer system 1 receives the measurement set and the information on the cotton supplier.

The server computer system 1 assigns to each received measurement set the information on the cotton supplier of the respective cotton sample. The received measurement set together with the assigned information on the cotton supplier is stored in a database 12 on the server computer system 1.

Various cotton samples can be provided by one and the same cotton supplier. In this case, it can be advantageous to distinguish and unambiguously identify not only the cotton suppliers, but also the cotton samples. For this purpose, in a preferred embodiment of the invention, the server computer system 1 additionally assigns to each measurement set a sample identifier for the respective cotton sample. The sample identifiers are stored in the database 12 together with the measurement sets.

It can further be advantageous to distinguish and unambiguously identify not only the cotton samples, but even single cotton bales 202 (cf FIG. 2). For this purpose, in a further embodiment of the invention, the server computer system 1 additionally assigns to each measurement set a bale identifier for the respective cotton bale 202. The bale identifiers are stored in the database 12 together with the measurement sets.

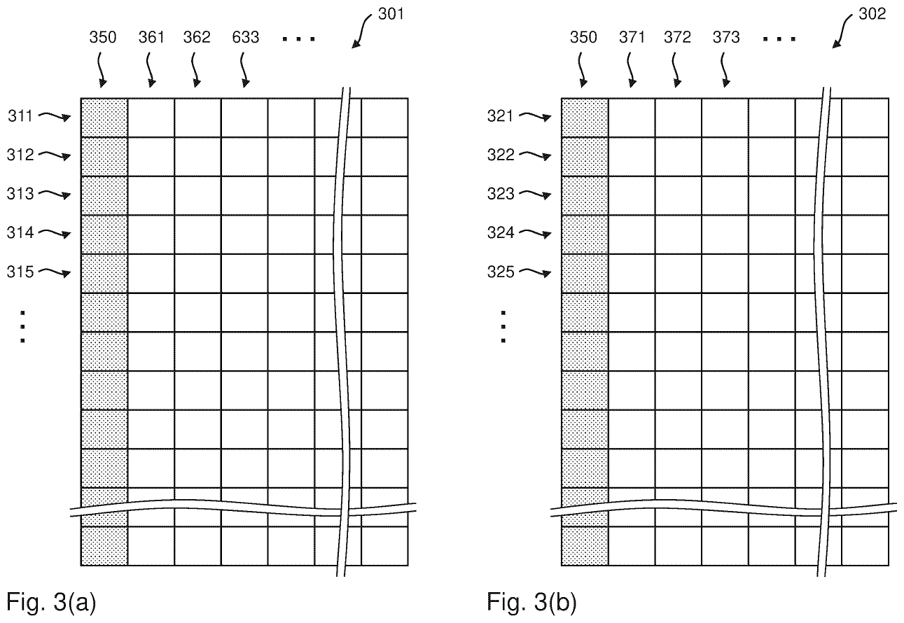

FIG. 3 schematically shows tables 301-304 of the database 12 implemented in the server computer system 1 according to the invention. In this non-limiting example, it is assumed that the database 12 is a relational database; other database models are known to the person skilled in the art and can be used for the present invention. Each row 311, 312, . . . ; 321, 322, . . . ; 331, 332, . . . , 341, 342, . . . of the tables 301-304 contains a tuple of data relating to a certain cotton sample.

The first column 350 of the first table 301 of FIG. 3(a) contains sample identifiers uniquely identifying the respective cotton sample. The second and subsequent columns 361, 362, . . . contain information on the cotton supplier who supplied the respective cotton sample. The information can include, e.g., the cotton supplier's name, postal address, country of residence, uniform resource locator (URL), e-mail address, phone number, etc. A unique supplier identifier identifying each cotton supplier 2 can be created by the server computer system 1 and also stored as information on the cotton supplier.

The first column 350 of the second table 302 of FIG. 3(b) contains the sample identifiers. The second and subsequent columns 371, 372, . . . contain measured values for various cotton-quality parameters measured for cotton from the respective cotton sample. The measured values in the second table 302 were determined on cotton bales 202 in a bale laydown 201 in an opening department 3 of a spinning-preparation plant (cf. FIG. 2).

Likewise, the first column 350 of the third table 303 of FIG. 3(c) contains the sample identifiers, and the second and subsequent columns 381, 382, . . . contain measured values for various cotton-quality parameters measured for cotton from the respective cotton sample. In contrast to second table 302, the measured values in the third table 303 were determined by a fiber-testing laboratory instrument.

The first column 350 of the fourth table 304 of FIG. 3(d) also contains the sample identifiers, whereas the second and subsequent columns 391, 392, . . . contain further information on the respective cotton sample. Such further information can be technical and/or non-technical. It may comprise, e.g., the following: plant variety, geographic origin, year of harvest, ginning mill, price, quantity supplied, and processor of the cotton sample.

The sample identifier may be assigned biuniquely to each received measurement set. In this case, the sample identifiers in the first columns 350 of each table 301-304 serve as a primary key for the database 12. The rows 311, 321, 331, 341 of the different tables 301-304 containing data related to the same cotton sample are linked to each other by means of the sample identifier in the first columns 350 of the rows 311, 321, 331, 341.

In an alternative embodiment, several sets of measured values can be determined for one and the same cotton sample, such that the sample identifiers cannot serve as a primary key. In this case, a surrogate key can be used to uniquely specify the tuples of the tables 301-304 of the database 12. Alternatively, other, natural keys can be used as a primary key for the database 12, e.g., a combination of the sample identifier and a time at which the corresponding measurement set was measured or received by the server computer system 12.

Turning again to FIG. 1, a buyer transmits from a client computer 8 via a global communication network 7 to the server computer system 1 a request 71 containing cotton specifications. The request 71 is received by the server computer system 1. The global communication network 7 for transmitting the purchase request 71 can be the same as or differ from the global communication network 6 for transmitting the measurement sets.

In a preferred embodiment, upon receipt of the request 71, the server computer system 1 retrieves or filters from the database 12 cotton samples that fulfill the buyer's specifications. The server computer system 1 statistically evaluates the retrieved measurement sets. The server computer system 1 transmits a result of the statistical evaluation comparing at least two different cotton suppliers, together with the information on the at least two cotton suppliers, via the global communication network 7 to the client computer from which it received the request 71. This transmission is indicated in FIG. 1 by an arrow 72.

In a first embodiment, the statistical evaluation can be produced based on all measurement sets stored in the database 12. In a second embodiment, the statistical evaluation can be produced based on a certain number, e.g., 100, of most recent measurement sets having the same assigned supplier identifier. In a third embodiment, the statistical evaluation can be produced based on most recent measurement sets measured in a certain time period, e.g., all measurement sets measured in the last six months.

In one embodiment, the statistical evaluation includes producing a ranking of the cotton suppliers. For producing the ranking, the server computer system 1 arranges the cotton suppliers on a scale according to the measurement sets assigned to them. It transmits the ranking via the global communication network 7 to the client computer 8, which outputs it to the buyer.

In the following, a fictitious example of producing a cotton-supplier ranking by the server computer system 1 is given. Raw cotton supplied by five cotton suppliers A-E is considered. The number of five is merely exemplary and in no way limiting; in general, the server computer system 1 can consider any natural number of cotton suppliers from the database 12. Table 1 lists coefficients of variation of five cotton-quality parameters that could be measured by the instrument USTER® HVI 1000 for various cotton samples supplied by each cotton supplier A-E.

TABLE 1

| | Coefficient of variation of: | | | | |
|---|---|---|---|---|---|
| | | | | Trash | Short |
| | | Bundle | | surface | fiber |
| Cotton | | strength | Reflectance | area | index |
| supplier | Micronaire | (g/tex) | (%) | (%) | (%) |
| A | 0.20 | 0.18 | 1.0 | 0.068 | 0.64 |
| B | 0.31 | 0.24 | 0.9 | 0.058 | 0.72 |
| C | 0.38 | 0.33 | 1.5 | 0.088 | 0.98 |
| D | 0.12 | 0.19 | 0.8 | 0.018 | 0.50 |
| E | 0.24 | 0.30 | 1.4 | 0.050 | 0.93 |

Each coefficient of variation listed in Table 1 is assigned a corresponding percentile value indicating the position of the coefficient of variation within a large basic population of coefficients of variation of the same parameter. Such percentile values can be retrieved from the well-known USTER® STATISTICS, from the database 12 or from another compilation of quality parameter values. By definition, each percentile value lies within the range between 0 and 100. The lower the percentile value, the better the corresponding coefficient of variation compared to the basic population. Table 2 shows the percentile values a-e assigned to the coefficients of variation of Table 1.

TABLE 2

| | | | | Trash | Short |
|---|---|---|---|---|---|
| | | Bundle | | surface | fiber |
| Cotton | Micronaire | strength | Reflectance | area | index |
| supplier | a | b | c | d | e |
| A | 20 | 21 | 36 | 40 | 35 |
| B | 57 | 48 | 35 | 24 | 66 |
| C | 79 | 70 | 58 | 61 | 89 |
| D | 8 | 22 | 16 | 5 | 22 |
| E | 44 | 63 | 52 | 21 | 80 |

A ranking r can be calculated, e.g., from the percentile values a-e of Table 2, according to the following formula:

$$r = 8.722 - ( 0.8 \; 15 \cdot log a ) - ( 0.8 \; 58 \cdot log b ) - ( 0.4 \; 72 \cdot log c ) - ( 0.8 \; 01 \cdot log d ) - ( 0.7 \; 88 \cdot log e ) ,$$

wherein the notation “log” denotes the common logarithm (to base 10). The higher the ranking r, the higher the consistency of the cotton samples supplied by the corresponding cotton supplier A-E. The thus calculated ranking values r are listed in the second column of Table 3.

TABLE 3

| Cotton | Ranking | Ranking | Ranking | Ranking | Ranking |
|---|---|---|---|---|---|
| supplier | r | r′ | r″ | r″′ | r″″ |
| A | 3.293 | 3 | ★★★ | 680 | 2 |
| B | 2.580 | 3 | ★★★ | 60 | 3 |
| C | 1.794 | 2 | ★★ | 20 | 5 |
| D | 4.648 | 5 | ★★★★★ | 100 | 1 |
| E | 2.470 | 2 | ★★ | 40 | 4 |

Rankings other than the ranking r discussed above are possible. The formula for the ranking r given above is merely an example; the person skilled in the art is able to find other appropriate formulae. The ranking can take into account only one of the cotton-quality parameters or more than one of the cotton-quality parameters, combining them by means of arithmetical and/or logical operators. The calculation of the ranking can be, e.g., based on percentile values as shown in Table 2, on the coefficients of variation as shown in Table 1, on mean values of measured parameters and/or on percentile values assigned to such mean values.

Table 3 gives examples of alternative rankings derived from the ranking r. A second ranking r′ in the third column is on a scale with natural numbers, whereas the ranking r is on a scale with rational numbers. The second ranking r′ can be derived by rounding the ranking r; moreover, it can be limited to a certain interval, e.g., to the natural numbers 1, 2, 3, 4, 5. The second ranking r′ may be simpler to grasp visually than the ranking r. However, such a simplification is at the expense of loss of information: in the example of Table 3, the cotton suppliers A and B, and C and E, respectively, have the same second ranking values r′, although their original ranking values r differ from one another.

A third ranking r″ in the fourth column of Table 3 corresponds to the second ranking r′ but represents the integer number by a corresponding number of graphical symbols, e.g., stars. Such a representation can be even simpler to grasp visually than the second ranking r′. The third ranking r″ can be interpreted as a classification system with five classes, each class being labelled by the corresponding number of stars. Each cotton suppliers A-E is classified into one of the classes.

A fourth ranking r′″ is on a scale with percentile values which indicate the position of the ranking value r within a sample consisting of, e.g., the five cotton suppliers A-E. For instance, a fourth ranking of r′″=60 means that 60% of the sample have the same or lower ranking values r than the corresponding cotton supplier B.

A fifth ranking r″″ in the sixth column of Table 3 simply depicts the order of the ranking r, 1 denoting the highest ranking value r and 5 denoting the lowest ranking value r.

The rankings r, r′, and r″ are on interval scales, indicating differences between the values. In contrast, the rankings r′″ and r″″ are on ordinal scales.

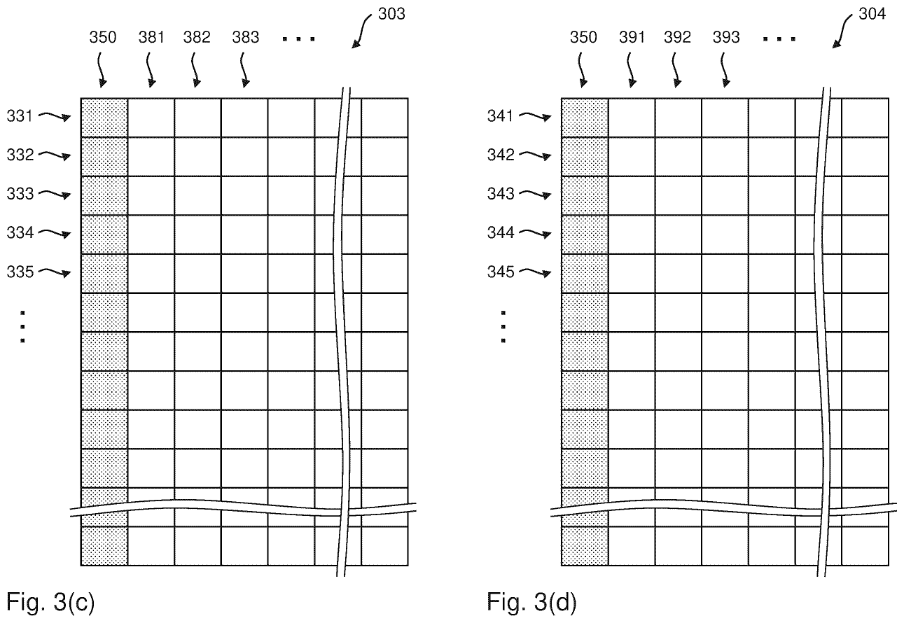

FIG. 4 shows a first example of a graphical representation 400 of a statistical evaluation that can be displayed on an output device of a client computer 8 after transmittal of the statistical evaluation from the server computer system 1 to the client computer 8. It shows curves 411, 412 representing measured values of a parameter a, plotted along a vertical axis 402, as a function of time t, plotted along a horizontal axis 401. The time t can be, e.g., the year of harvest. The quality-parameter values are plotted for two cotton samples supplied in each year by two different cotton suppliers A and B. Alternatively, the curves 411, 412 can show mean values of all values measured in the respective year for each cotton supplier A and B, respectively. Information on the cotton suppliers, e.g., their names “A” and “B”, is provided such that each curve 411, 412 is linked with the corresponding cotton supplier A and B, respectively. Further curves 413, 414 indicate maximum parameter values and minimum parameter values, respectively, measured in the respective year and stored in the database 12. Still further information could be plotted, such as measures of dispersion of the measured values. More than two cotton suppliers can be considered.

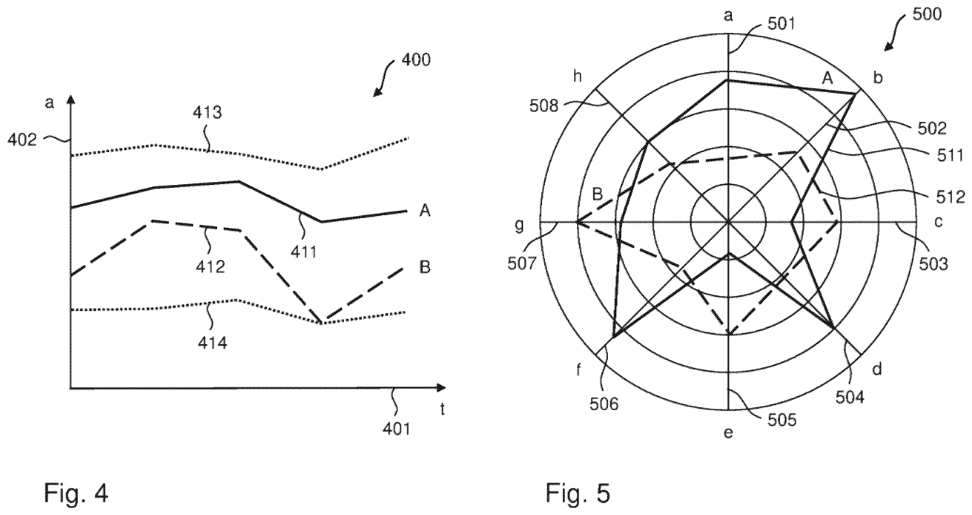

A second example of a graphical representation 500 of a statistical evaluation that can be displayed on an output device of a client computer 8 is shown in FIG. 5. It is a radar diagram in which closed curves 511, 512 represent measured values of eight parameters a-h on axes 501-508. Each axis 501-508 can be scaled such that the axis maximum corresponds to the maximum value stored in the database 12 for the corresponding parameter. Alternatively, percentiles corresponding to the measured values can be taken from the USTER® STATISTICS and plotted in the radar diagram. The quality-parameter values are plotted for two cotton samples supplied by two different cotton suppliers A and B. Alternatively, the diagram 500 can show mean values of all values measured for each cotton supplier A and B, respectively. Information on the cotton suppliers, e.g., their names “A” and “B”, is provided such that each closed curve 511, 512 is linked with the corresponding cotton supplier A and B, respectively. Still further information could be plotted, such as measures of dispersion of the measured values. More than two cotton suppliers can be considered.

The diagrams 400, 500 of FIGS. 4 and 5, respectively, show clear differences between the cotton suppliers A and B. For instance, as can be seen from FIG. 4, the cotton samples supplied by cotton supplier A had clearly higher parameter values that those supplied by cotton supplier B. It depends on the quality parameter a whether higher or lower parameter values are perceived as indicating a “higher quality”. A cotton buyer can extrapolate the findings from the past, which have been transmitted to the client computer 8, to the future and select the cotton supplier that best meets their need for a future purchase of cotton.

It is understood that the present invention is not limited to the embodiments discussed above. With knowledge of the invention, the person skilled in the art will be able to derive further variants which are also part of the subject matter of the present invention.

### LIST OF REFERENCE NUMERALS

1 Server computer system
11, 13 Communication means
12 Database
2.1-2.3 Spinning mills
2.4 Cotton-classing office
3 Opening department
4 Textile laboratory
5 Cloud connector
6 Global communication network
61 Data transmission
7 Global communication network
71 Request
72 Data transmission
8 Client computer
301-304 Tables of the database 12
311, 312, . . . Rows of the first table 301
321, 322, . . . Rows of the second table 302
331, 332, . . . Rows of the third table 303
341, 342, . . . Rows of the fourth table 304
350, 361, 362, . . . Columns of the first table 301
350, 371, 371, . . . Columns of the second table 302
350, 381, 382, . . . Columns of the third table 303
350, 391, 392, . . . Columns of the fourth table 304
400 First graphical representation
401, 402 Diagram axes
411-414 Curves
500 Second graphical representation
501-508 Diagram axes
511, 512 Closed curves

1. A computer-implemented method for assessing cotton suppliers (A, B) supplying raw cotton to cotton processors (2.1-2.4), comprising the steps of:
receiving by a server computer system (1) via a global communication network (6) from at least one cotton processor (2.1-2.4)
measurement sets for different cotton samples, each measurement set comprising at least one measured value for at least one cotton-quality parameter (a-h) measured for the respective cotton sample, and
information on the cotton supplier (A, B) of the respective cotton sample;
assigning by the server computer system (1) to each measurement set the information on the cotton supplier (A, B) of the respective cotton sample;
storing in a database (12) on the server computer system (1) the measurement sets together with the assigned information on the cotton supplier (A, B);
statistically evaluating the measurement sets by the server computer system (1); and
transmitting a result of the statistical evaluation comparing at least two different cotton suppliers (A, B), together with the information on the at least two cotton suppliers (A, B), from the server computer system (1) via a global communication network (7) to a client computer (8).

2. The computer-implemented method according to claim 1, wherein the at least one measured value is determined on a cotton bale (202) in a bale laydown (201) in an opening department (3) of a spinning-preparation plant.

3. The computer-implemented method according to claim 2, wherein the at least one cotton-quality parameter is at least one element of the following set: humidity, reflectance, color characteristics, contamination content, color characteristics of contaminations, type of contaminations.

4. The computer-implemented method according to claim 1, wherein the at least one measured value is determined in a textile laboratory (4) by a fiber-testing laboratory instrument.

5. The computer-implemented method according to claim 4, wherein the at least one cotton-quality parameter (a-h) is at least one element of the following set: reflectance, color characteristics, fiber length, fiber strength, tensile properties, short-fiber characteristics, trash-particle content, trash-particle size, nep content, nep size, fiber-fineness characteristics, fiber-maturity characteristics, micronaire.

6. The computer-implemented method according to claim 2, wherein each of the measurement sets comprises at least one first measured value determined on a cotton bale (202) in a bale laydown (201) in an opening department (3) of a spinning-preparation plant and at least one second measured value determined in a textile laboratory (4) by a fiber-testing laboratory instrument.

7. The computer-implemented method according to claim 1, further comprising the steps of:
assigning by the server computer system (1) to each measurement set a sample identifier for the respective cotton sample; and
storing in the database (12) the sample identifiers together with the measurement sets.

8. The computer-implemented method according to claim 7, further comprising the steps of:
receiving by the server computer system (1) via the global communication network (6) from the at least one cotton processor (2) further information on the cotton samples;
assigning by the server computer system (1) to each piece of further information the sample identifier for the respective cotton sample; and
storing in the database (12) the further information together with the measurement sets.

9. The computer-implemented method according to claim 8, wherein the further information is from the following set: plant variety, geographic origin, year of harvest, ginning mill, price, quantity supplied, processor (2.1-2.4) of the cotton sample.

10. The computer-implemented method according to claim 1, wherein the raw cotton is supplied in the form of cotton bales (202) to the at least one cotton processor (2.1-2.4), further comprising the steps of:
assigning by the server computer system (1) to each measurement set a bale identifier for the respective cotton bale (202); and
storing in the database (12) the bale identifiers together with the measurement sets.

11. The computer-implemented method according to claim 1, wherein the statistical evaluation is based on all measurement sets stored in the database (12), based on a certain number of most recent measurement sets, or based on most recent measurement sets measured in a certain time period.

12. The computer-implemented method according to claim 1, wherein the statistical evaluation includes producing a ranking of the cotton suppliers (A, B), and the ranking is transmitted from the server computer system (1) via the global communication network (7) to the client computer (8).

13. The computer-implemented method according to claim 12, wherein the ranking is produced on an ordinal scale, on an interval scale or on a ratio scale.

14. The computer-implemented method according to claim 12, wherein the ranking is in the form of measured values, in the form of quantiles or percentiles, in the form of ordinal numbers, or in the form of classes.

15. A server computer system (1) comprising means for carrying out the method according to claim 1.

16. A computer program having instructions which when executed by a server computer system (1) cause the server computer system (1) to perform the method according to claim 1.

17. A server computer system (1) for assessing cotton suppliers (A, B) supplying raw cotton to cotton processors (2.1-2.4), comprising:
a receiver (11) for receiving via a global communication network (6) from at least one cotton processor (2)
measurement sets for different cotton samples, each measurement set comprising at least one measured value for at least one cotton-quality parameter (a-h) measured for the respective cotton sample, and
information on the cotton supplier (A, B) of the respective cotton sample;
a processor configured to assign to each measurement set the information on the cotton supplier (A, B) of the respective cotton sample;
a memory for storing in a database (12) the measurement sets together with the assigned information on the cotton supplier (A, B);
a processor configured to statistically evaluate the measurement sets; and
a transmitter (13) for transmitting a result of the statistical evaluation comparing at least two different cotton suppliers (A, B), together with the information on the at least two cotton suppliers (A, B), from the server computer system (1) via a global communication network (7) to a client computer (8).
